(19) United States
(12) Patent Application Publication
(10) Pub. No.: US 2009/0148359 A1
(43) Pub. Date: Jun. 11, 2009

(54) PHOTOCATALYTIC REACTION SYSTEMS FOR WATER PURIFICATION

(75) Inventors: Hsin Shao, Hsinchu (TW); Min-Chao Chang, Hsinchu City (TW); Ren-Yang Horng, Hsinchu (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 12/043,104

(22) Filed: Mar. 5, 2008

(30) Foreign Application Priority Data
Dec. 5, 2007 (TW) TW96146275

(51) Int. Cl. B01J 19/08

(52) U.S. Cl. 422/186.3

(57) ABSTRACT

A photocatalytic reaction system for water purification. At least one light source is disposed in a photocatalytic reaction tank. Multiple photocatalyst carriers are disposed in the photocatalytic reaction tank and surround the light source. Each photocatalyst carrier carries a plurality of photocatalyst particles. A photocatalysts separation tank is connected to the photocatalytic reaction tank. A non-woven fabric membrane filtration module is disposed in the photocatalysts separation tank, filtering off the photocatalyst particles. An input pump is connected to the photocatalytic reaction tank, inputting water thereto. An output pump is connected to the non-woven fabric membrane filtration module, outputting the water to the exterior of the photocatalysts separation tank.

### BACKGROUND OF THE INVENTION

1. Field of the Invention

The invention relates to photocatalytic reaction systems for water purification, and more particularly to photocatalytic reaction systems with enhanced efficiency for water purification.

2. Description of the Related Art

Photocatalysts, such as TiO₂, can provide functions of environmental purification, thereby achieving effects of getting rid of dirt, antisepsis, and odor removal. For example, when TiO₂ exists in water and is subjected to proper light irradiation, hydroxyl radicals (OH.), which possess intense oxidant capacity, are generated on the surface of TiO₂, decomposing pollutants (or organic compounds) attached to the surface of TiO₂ into carbon dioxide (CO₂) and water (H₂O).

Photocatalytic application in pollution prevention may be a purification technique for obtaining highly cleaned water and air. When applied to water treatment, the photocatalysts can effectively and safely oxidate and thus replace ozone and chlorine to remove water pollutants and disinfect bacteria in water. Namely, when the photocatalysts is applied to water treatment, advanced oxidation technology (AOT) utilizing hydroxyl radicals as an oxidant is provided. For example, water recycling or treatment of high-purity water may be achieved by application of the photocatalysts.

Generally, when practically applied to water treatment, the photocatalysts is fixed to a carrier or dispersed in the water in a suspended manner.

Regarding the technique with which the photocatalysts is fixed to a carrier, a carrier photocatalytic reactor (CPR) is used. The carrier is constructed to provide a specific profile. The photocatalyst particles are fixed to the surface of the carrier using a physical or chemical method, performing photocatalytic reaction. Accordingly, as the photocatalyst particles are fixed to the surface of the carrier, separation of the photocatalyst particles from water can be simplified.

Regarding the technique with which the photocatalysts is dispersed in the water in a suspended manner, a slurry photocatalytic reactor (SPR) is employed. As the photocatalyst particles are dispersed in the water, separation of the photocatalyst particles from the water is complex. As a whole, sedimentation, flotation, and membrane filtration methods are commonly used to separate the photocatalyst particles from the water. Regarding the membrane filtration method, a membrane may serve as a photocatalysts barrier capable of providing a filtration effect. Additionally, the membrane may be an ultra-filtration membrane or a micro-filtration membrane. As the ultra-filtration and micro-filtration membranes are micro-porous membranes, operational costs and pressure provided thereby are high and maintenance thereof is complicated. Specifically, the photocatalyst particles often obstruct miniature apertures on the surface of the membrane, reducing filtration flux provided by the membrane, and further increasing a trans-membrane pressure applied to the membrane. Accordingly, to increase the filtration flux, the membrane must be replaced frequently. The operational costs of water treatment, however, are increased.

Regarding the technique with which a membrane is assembled to a photocatalytic reactor, the membrane is disposed in the exterior or interior of the photocatalytic reactor. Disposed in the exterior of the photocatalytic reactor, the membrane is not directly subjected to irradiation of a light source (ultraviolet), such that selection of the membrane material is flexible and commercial application of the photocatalytic reactor is available. In another aspect, disposed in the interior of the photocatalytic reactor, the membrane is directly subjected to the irradiation of the light source (ultraviolet). Photolysis stability provided by the membrane material is thus critical. Namely, the selection of the membrane material is limited, thereby increasing the operational costs of the water treatment.

Hence, there is a need for a photocatalytic reaction system providing effective water purification with low operational costs and simplified operation.

### BRIEF SUMMARY OF THE INVENTION

A detailed description is given in the following embodiments with reference to the accompanying drawings.

An exemplary embodiment of the invention provides a photocatalytic reaction system for water purification, comprising a photocatalytic reaction tank, at least one light source, a plurality of photocatalyst carriers, a photocatalysts separation tank, a non-woven fabric membrane filtration module, an input pump, and an output pump. The light source is disposed in the photocatalytic reaction tank. The photocatalyst carriers are disposed in the photocatalytic reaction tank and surround the light source. Each photocatalyst carrier carries a plurality of photocatalyst particles. The photocatalysts separation tank is connected to the photocatalytic reaction tank. The non-woven fabric membrane filtration module is disposed in the photocatalysts separation tank, filtering off the photocatalyst particles. The input pump is connected to the photocatalytic reaction tank, inputting water thereto. The output pump is connected to the non-woven fabric membrane filtration module, outputting the water to the exterior of the photocatalysts separation tank.

The photocatalytic reaction system for water purification further comprises an air pump and a first air dispersion device connected thereto and disposed in the photocatalysts separation tank and under the non-woven fabric membrane filtration module.

The photocatalytic reaction system for water purification further comprises a second air dispersion device connected to the air pump and disposed in the photocatalytic reaction tank.

The second air dispersion device is disposed under the photocatalyst carriers.

The wavelength of light output from the light source is between 250 nm and 500 nm.

The length of each photocatalyst carrier is between 1 mm and 30 mm.

Each photocatalyst carrier comprises non-woven fabric.

Each photocatalyst carrier comprises PMMA, PS, PC, PET, PP, PE, or TPX.

The non-woven fabric membrane filtration module comprises a plurality of non-woven fabric membranes, and the diameter of apertures in each non-woven fabric membrane is between 0.03 μm and 30 μm.

Each non-woven fabric membrane comprises PMMA, PS, PC, PET, PP, PE, or TPX.

### BRIEF DESCRIPTION OF THE DRAWINGS

The invention can be more fully understood by reading the subsequent detailed description and examples with references made to the accompanying drawings, wherein:

FIG. 1 is a schematic side view of a photocatalytic reaction system for water purification of a first embodiment of the invention;

FIG. 2 is a schematic top view of a photocatalytic reaction tank and a photocatalysts separation tank of the photocatalytic reaction system for water purification of the first embodiment of the invention;

FIG. 3 is a schematic side view of a photocatalytic reaction system for water purification of a second embodiment of the invention; and

FIG. 4 is a schematic top view of a photocatalytic reaction tank and a photocatalysts separation tank of the photocatalytic reaction system for water purification of the second embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

### First Embodiment

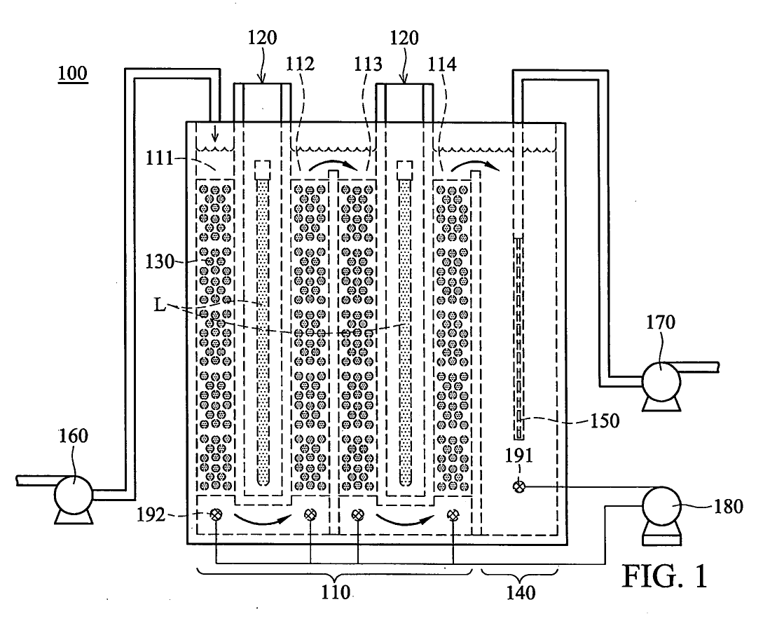

Referring to FIG. 1, a photocatalytic reaction system 100 for water purification may be referred to as a ‘carrier photocatalytic reaction system’ for water purification and comprises a photocatalytic reaction tank 110, two light sources 120, a plurality of photocatalyst carriers 130, a photocatalysts separation tank 140, a non-woven fabric membrane filtration module 150, an input pump 160, an output pump 170, an air pump 180, a first air dispersion device 191, and a plurality of second air dispersion devices 192.

In this embodiment, the photocatalytic reaction tank 110 is divided into a first tank chamber 111, a second tank chamber 112, a third tank chamber 113, and a fourth tank chamber 114, and all accommodating water, foul water, or waste water, which needs to be purified.

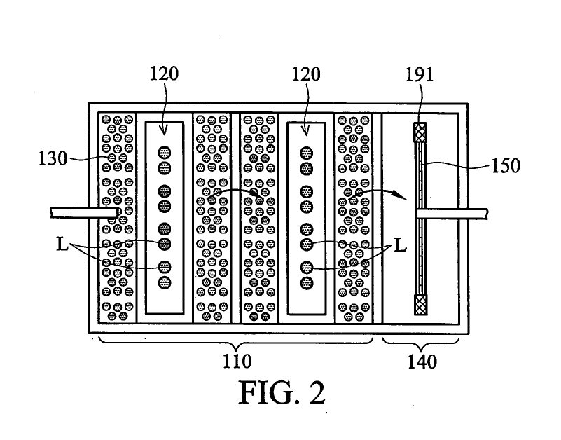

The light sources 120 are disposed in the photocatalytic reaction tank 110. Specifically, the light sources 120 are disposed between the first tank chamber 111 and the second tank chamber 112 and between the third tank chamber 113 and the fourth tank chamber 114, respectively. Additionally, as shown in FIG. 2, each light source 120 comprises a plurality of lamp tubes L. In this embodiment, the wavelength of light output from the light sources 120 or lamp tubes L is between 250 nm and 500 nm.

As shown in FIG. 1 and FIG. 2, the photocatalyst carriers 130 are disposed in the photocatalytic reaction tank 110 and surround the light sources 120. Specifically, the photocatalyst carriers 130 are respectively disposed in the first tank chamber 111, second tank chamber 112, third tank chamber 113, and fourth tank chamber 114 of the photocatalytic reaction tank 110, thus surrounding the light sources 120. Each photocatalyst carrier 130 carries a plurality of photocatalyst particles (not shown). The photocatalyst particles may be TiO₂ with a diameter between 0.005 μm and 10 μm. Moreover, the length of each photocatalyst carrier 130 is between 1 mm and 30 mm and each photocatalyst carrier 130 may comprise non-woven fabric comprising PMMA, PS, PC, PET, PP, PE, or TPX. Accordingly, as fibers of the non-woven fabric form a porous structure, the photocatalyst particles can be immobilized in the photocatalyst carriers 130. Namely, the photocatalyst particles can be immobilized in the photocatalyst carriers 130 in advance, such that the amount or concentration of the photocatalyst particles suspending in the photocatalytic reaction tank 110 is significantly reduced.

The photocatalysts separation tank 140 is connected to the photocatalytic reaction tank 110. Specifically, the photocatalysts separation tank 140 is connected to the fourth tank chamber 114 of the photocatalytic reaction tank 110.

The non-woven fabric membrane filtration module 150 is disposed in the photocatalysts separation tank 140 and comprises a plurality of non-woven fabric membranes (not shown). Specifically, each non-woven fabric membrane may comprise PMMA, PS, PC, PET, PP, PE, or TPX and the diameter of apertures in each non-woven fabric membrane is between 0.03 μm and 30 μm. Accordingly, as the non-woven fabric has multilayer fibers which are irregularly interlaced, i.e. the fibers in the non-woven fabric are interlaced to form irregular and connected curved apertures and passages, filtration functions such as interception, inertial impaction, and Brownian diffusion are provided. Thus, the non-woven fabric can intercept particles with a size much less than that of the apertures of the non-woven fabric and maintain superior capability of flow penetration.

As shown in FIG. 1, the input pump 160 is connected to the photocatalytic reaction tank 110, inputting water, foul water, or waste water, which needs to be purified, thereto. In this embodiment, the input pump 160 is connected to the first tank chamber 111 of the photocatalytic reaction tank 110.

The output pump 170 is connected to the non-woven fabric membrane filtration module 150 disposed in the photocatalysts separation tank 140, outputting the water, which has been purified, to the exterior of the photocatalysts separation tank 140 (or photocatalytic reaction system 100).

The air pump 180 is connected to the first air dispersion device 191 and second air dispersion devices 192.

The first air dispersion device 191 is disposed in the photocatalysts separation tank 140 and under the non-woven fabric membrane filtration module 150.

The second air dispersion devices 192 are disposed in the photocatalytic reaction tank 110 and supply air (or oxygen) into the water, foul water, or waste water therein, facilitating photocatalytic reaction. Specifically, the second air dispersion devices 192 are respectively disposed in the first tank chamber 111, second tank chamber 112, third tank chamber 113, and fourth tank chamber 114 of the photocatalytic reaction tank 110 and under the photocatalyst carriers 130.

The following description is directed to operation of water purification of the photocatalytic reaction system 100.

The water, foul water, or waste water, which needs to be purified, is input to the photocatalytic reaction tank 110 by the input pump 160. Specifically, the water, foul water, or waste water sequentially flows through the first tank chamber 111, second tank chamber 112, third tank chamber 113, and fourth tank chamber 114 in a longitudinally circulating manner. Here, pollutants (or organic compounds) in the water are attached to the surface of the photocatalyst particles (TiO₂) immobilized in the photocatalyst carriers 130. When the photocatalyst particles (TiO₂) is subjected to irradiation of the light sources 120, hydroxyl radicals (OH.), which possess intense oxidant capacity, are generated on the surface of photocatalyst particles (TiO₂), decomposing the pollutants (or organic compounds) attached to the surface of photocatalyst particles (TiO₂) into carbon dioxide (CO₂) and water (H₂O).

The water, which has been purified by photocatalytic reaction, can then flow into the photocatalysts separation tank 140 from the fourth tank chamber 114 of the photocatalytic reaction tank 110. At this point, few photocatalyst particles (TiO₂) may suspend in the water in the photocatalysts separation tank 140. When the water is drawn through the non-woven fabric membrane filtration module 150 by the output pump 170, the photocatalyst particles (TiO₂) can be separated from the water by interception of the non-woven fabric membrane filtration module 150 (or non-woven fabric membranes). Thus, the water drawn from the photocatalysts separation tank 140 by the output pump 170 is clean and contains no photocatalyst particle (TiO₂). Moreover, the first air dispersion device 191 disposed under the non-woven fabric membrane filtration module 150 continuously disperses air into the water, forming bubbles flushing upward. These upward flushing bubbles generate shear force of cross flow on the surface of the non-woven fabric membrane filtration module 150 (or non-woven fabric membranes), thereby removing the photocatalyst particles (TiO₂) therefrom. Accordingly, the photocatalyst particles (TiO₂) do not excessively accumulate on the surface of the non-woven fabric membrane filtration module 150 (or non-woven fabric membranes), such that the entire non-woven fabric membrane filtration module 150 can provide stable filtration flux and trans-membrane pressure when filtering off the photocatalyst particles (TiO₂).

### Second Embodiment

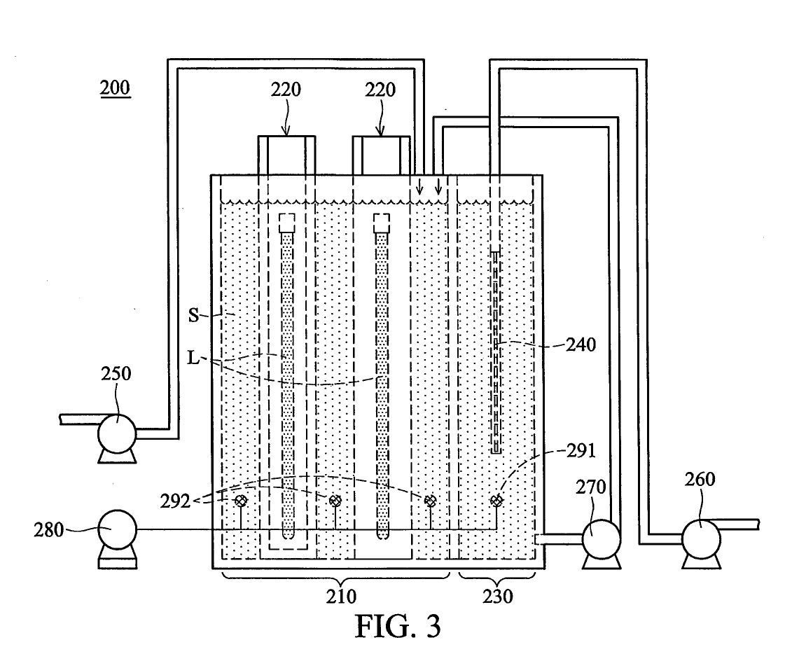

Referring to FIG. 3, a photocatalytic reaction system 200 for water purification may be referred to as a ‘slurry photocatalytic system’ for water purification and comprises a photocatalytic reaction tank 210, four light sources 220, a photocatalysts separation tank 230, a non-woven fabric membrane filtration module 240, an input pump 250, an output pump 260, a circulation pump 270, an air pump 280, a first air dispersion device 291, and a plurality of second air dispersion devices 292.

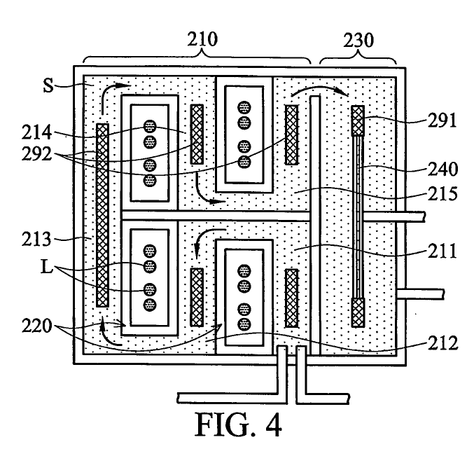

As shown in FIG. 4, the photocatalytic reaction tank 210 is divided into a first tank chamber 211, a second tank chamber 212, a third tank chamber 213, a fourth tank chamber 214, and a fifth tank chamber 215, and all accommodates a photocatalysts suspension solution S containing a plurality of photocatalyst particles (not shown). Here, the photocatalyst particles may be TiO₂ with a diameter between 0.005 μm and 10 μm.

The light sources 220 are disposed in the photocatalytic reaction tank 210 and surrounded by the photocatalysts suspension solution S. Specifically, the light sources 220 are respectively and alternately disposed between the first tank chamber 211 and the second tank chamber 212, between the second tank chamber 212 and the third tank chamber 213, between the third tank chamber 213 and the fourth tank chamber 214, and between the fourth tank chamber 214 and the fifth tank chamber 215. Additionally, as shown in FIG. 4, each light source 220 comprises a plurality of lamp tubes L. In this embodiment, the wavelength of light output from the light sources 220 or lamp tubes L is between 250 nm and 500 nm.

The photocatalysts separation tank 230 is connected to the photocatalytic reaction tank 210 and accommodates the photocatalysts suspension solution S. Specifically, the photocatalysts separation tank 230 is connected to the fifth tank chamber 215 of the photocatalytic reaction tank 210.

The non-woven fabric membrane filtration module 240 is disposed in the photocatalysts separation tank 230 and comprises a plurality of non-woven fabric membranes (not shown). Specifically, each non-woven fabric membrane may comprise PMMA, PS, PC, PET, PP, PE, or TPX and the diameter of apertures in each non-woven fabric membrane is between 0.03 μm and 30 μm. Accordingly, as the non-woven fabric has multilayer fibers which are irregularly interlaced, i.e. the fibers in the non-woven fabric are interlaced to form irregular and connected curved apertures and passages, filtration functions such as interception, inertial impaction, and Brownian diffusion are provided. Thus, the non-woven fabric can intercept particles with a size much less than that of the apertures of the non-woven fabric and maintain superior capability of flow penetration.

As shown in FIG. 3, the input pump 250 is connected to the photocatalytic reaction tank 210, inputting water, foul water, or waste water, which needs to be purified, thereto. In this embodiment, the input pump 250 is connected to the first tank chamber 211 of the photocatalytic reaction tank 210.

The output pump 260 is connected to the non-woven fabric membrane filtration module 240 disposed in the photocatalysts separation tank 230, outputting the water, which has been purified, to the exterior of the photocatalysts separation tank 230 (or photocatalytic reaction system 200).

The circulation pump 270 is connected between the photocatalysts separation tank 230 and the first tank chamber 211 of the photocatalytic reaction tank 210, circulating the photocatalysts suspension solution S from the photocatalysts separation tank 230 to the first tank chamber 211 of the photocatalytic reaction tank 210.

The air pump 280 is connected to the first air dispersion device 291 and second air dispersion devices 292.

The first air dispersion device 291 is disposed in the photocatalysts separation tank 230 and under the non-woven fabric membrane filtration module 240.

The second air dispersion devices 292 are disposed in the photocatalysts suspension solution S in the photocatalytic reaction tank 210 and supply air (or oxygen) into the photocatalysts suspension solution S, enabling the photocatalyst particles (TiO₂) to uniformly suspend therein, and further facilitating photocatalytic reaction. Specifically, the second air dispersion devices 292 are respectively disposed in the first tank chamber 211, second tank chamber 212, third tank chamber 213, fourth tank chamber 214, and fifth tank chamber 215 of the photocatalytic reaction tank 210.

The following description is directed to operation of water purification of the photocatalytic reaction system 200.

The water, foul water, or waste water, which needs to be purified, is input to the photocatalytic reaction tank 210 by the input pump 250 and mixed with the photocatalysts suspension solution S. Specifically, the photocatalysts suspension solution S sequentially flows through the first tank chamber 211, second tank chamber 212, third tank chamber 213, fourth tank chamber 214, and fifth tank chamber 215 in a transversely circulating manner. Here, pollutants (or organic compounds) in the photocatalysts suspension solution S are attached to the surface of the photocatalyst particles (TiO₂). When the photocatalyst particles (TiO₂) is subjected to irradiation of the light sources 220, hydroxyl radicals (OH.), which possess intense oxidant capacity, are generated on the surface of photocatalyst particles (TiO₂), decomposing the pollutants (or organic compounds) attached to the surface of photocatalyst particles (TiO₂) into carbon dioxide (CO₂) and water (H₂O).

The photocatalysts suspension solution S can then flow into the photocatalysts separation tank 140 from the fifth tank chamber 215 of the photocatalytic reaction tank 210. At this point, massive photocatalyst particles (TiO₂) still suspend in the photocatalysts suspension solution S in the photocatalysts separation tank 230. When the water is drawn through the non-woven fabric membrane filtration module 240 by the output pump 260, the photocatalyst particles (TiO₂) can be separated from the photocatalysts suspension solution S by interception of the non-woven fabric membrane filtration module 240 (or non-woven fabric membranes). Thus, the water drawn from the photocatalysts separation tank 230 by the output pump 260 is clean and contains no photocatalyst particle (TiO₂). Similarly, the first air dispersion device 291 disposed under the non-woven fabric membrane filtration module 240 continuously disperses air into the photocatalysts suspension solution S, forming bubbles flushing upward. These upward flushing bubbles generate shear force of cross flow on the surface of the non-woven fabric membrane filtration module 240 (or non-woven fabric membranes), thereby removing the photocatalyst particles (TiO₂) therefrom. Accordingly, the photocatalyst particles (TiO₂) do not excessively accumulate on the surface of the non-woven fabric membrane filtration module 240 (or non-woven fabric membranes), such that the entire non-woven fabric membrane filtration module 240 can provide stable filtration flux and trans-membrane pressure when filtering off the photocatalyst particles (TiO₂).

In another aspect, as the circulation pump 270 circulates the photocatalysts suspension solution S from the photocatalysts separation tank 230 to the first tank chamber 211 of the photocatalytic reaction tank 210, the concentration of the photocatalyst particles (TiO₂) in the photocatalysts suspension solution S in the photocatalysts separation tank 230 is not excessively high and the concentration or amount of the photocatalyst particles (TiO₂) in the photocatalysts suspension solution S in the photocatalytic reaction tank 210 can be balanced, facilitating photocatalytic reaction in the photocatalytic reaction tank 210.

In conclusion, the disclosed photocatalytic reaction systems for water purification have many advantages. As the non-woven fabric membrane filtration modules can provide stable filtration flux and trans-membrane pressure when filtering off the photocatalyst particles, the efficiency of water purification performed by the photocatalytic reaction systems is enhanced. Moreover, as the photocatalyst particles are easily separated from the water or photocatalysts suspension solution, good water quality can be provided in obtaining clean water. Additionally, as the efficiency of the water purification performed by the photocatalytic reaction systems is enhanced, the photocatalytic reaction systems can be operated with high hydraulic loading. Furthermore, the non-woven fabric membrane filtration modules (or non-woven fabric membranes) are cheap and can be continuously used, thereby reducing overall operational costs of the photocatalytic reaction systems.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A photocatalytic reaction system for water purification, comprising:
a photocatalytic reaction tank;
at least one light source disposed in the photocatalytic reaction tank;
a plurality of photocatalyst carriers disposed in the photocatalytic reaction tank and surrounding the light source, wherein each photocatalyst carrier carries a plurality of photocatalyst particles;
a photocatalysts separation tank connected to the photocatalytic reaction tank;
a non-woven fabric membrane filtration module disposed in the photocatalysts separation tank, filtering off the photocatalyst particles;
an input pump connected to the photocatalytic reaction tank, inputting water thereto; and
an output pump connected to the non-woven fabric membrane filtration module, outputting the water to the exterior of the photocatalysts separation tank.

2. The photocatalytic reaction system for water purification as claimed in claim 1, further comprising an air pump and a first air dispersion device connected thereto and disposed in the photocatalysts separation tank and under the non-woven fabric membrane filtration module.

3. The photocatalytic reaction system for water purification as claimed in claim 2, further comprising a second air dispersion device connected to the air pump and disposed in the photocatalytic reaction tank.

4. The photocatalytic reaction system for water purification as claimed in claim 3, wherein the second air dispersion device is disposed under the photocatalyst carriers.

5. The photocatalytic reaction system for water purification as claimed in claim 1, wherein the wavelength of light output from the light source is between 250 nm and 500 nm.

6. The photocatalytic reaction system for water purification as claimed in claim 1, wherein the length of each photocatalyst carrier is between 1 mm and 30 mm.

7. The photocatalytic reaction system for water purification as claimed in claim 1, wherein each photocatalyst carrier comprises non-woven fabric.

8. The photocatalytic reaction system for water purification as claimed in claim 1, wherein each photocatalyst carrier comprises PMMA, PS, PC, PET, PP, PE, or TPX.

9. The photocatalytic reaction system for water purification as claimed in claim 1, wherein the non-woven fabric membrane filtration module comprises a plurality of non-woven fabric membranes, and the diameter of apertures in each non-woven fabric membrane is between 0.03 μm and 30 μm.

10. The photocatalytic reaction system for water purification as claimed in claim 9, wherein each non-woven fabric membrane comprises PMMA, PS, PC, PET, PP, PE, or TPX.

11. A photocatalytic reaction system for water purification, comprising:
a photocatalytic reaction tank accommodating a photocatalysts suspension solution containing a plurality of photocatalyst particles;
at least one light source disposed in the photocatalytic reaction tank and surrounded by the photocatalysts suspension solution;
a photocatalysts separation tank connected to the photocatalytic reaction tank and accommodating the photocatalysts suspension solution;
a non-woven fabric membrane filtration module disposed in the photocatalysts separation tank, filtering off the photocatalyst particles of the photocatalysts suspension solution;
an input pump connected to the photocatalytic reaction tank, inputting water thereto;
an output pump connected to the non-woven fabric membrane filtration module, outputting the water to the exterior of the photocatalysts separation tank; and
a circulation pump connected between the photocatalysts separation tank and the photocatalytic reaction tank, circulating the photocatalysts suspension solution from the photocatalysts separation tank to the photocatalytic reaction tank.

12. The photocatalytic reaction system for water purification as claimed in claim 11, further comprising an air pump and a first air dispersion device connected thereto and disposed in the photocatalysts separation tank and under the non-woven fabric membrane filtration module.

13. The photocatalytic reaction system for water purification as claimed in claim 12, further comprising a second air dispersion device connected to the air pump and disposed in the photocatalysts suspension solution in the photocatalytic reaction tank.

14. The photocatalytic reaction system for water purification as claimed in claim 11, wherein the wavelength of light output from the light source is between 250 nm and 500 nm.

15. The photocatalytic reaction system for water purification as claimed in claim 11, wherein the non-woven fabric membrane filtration module comprises a plurality of non-woven fabric membranes, and the diameter of apertures in each non-woven fabric membrane is between 0.03 μm and 30 μm.

16. The photocatalytic reaction system for water purification as claimed in claim 15, wherein each non-woven fabric membrane comprises PMMA, PS, PC, PET, PP, PE, or TPX.
